(19) United States
(12) Patent Application Publication
(10) Pub. No.: US 2021/0254721 A1
(43) Pub. Date: Aug. 19, 2021

(54) MECHANICAL SEAL WITH A SEAL FACE HAVING CHANNELS

(71) Applicant: JOHN CRANE INC., CHICAGO, IL (US)

(72) Inventor: Wei-Tang LAI, Hoffman Estates, IL (US)

(21) Appl. No.: 16/972,692

(22) PCT Filed: Jun. 4, 2019
(86) PCT No.: PCT/US2019/035305

§ 371 Date: Dec. 7, 2020

Related U.S. Application Data
(60) Provisional application No. 62/682,496, filed on Jun. 8, 2018.

(51) Int. Cl. F16J 15/34; F16C 33/74; B23K 26/364

(52) U.S. Cl. CPC F16J 15/3416; B23K 26/364; F16C 33/741

(57) ABSTRACT

A seal assembly to seal fluid under pressure may include a pair of annular mating rings with seal faces. At least one of the seal faces may define a sealing interface between a radially inner edge and a radially outer edge of one of the rings. At least one of the seal faces may include a channel for receiving the fluid under pressure. The channel may include a circumferential channel and one or more radial channels. The radial channels may include a first radial channel extending from the circumferential channel to a first edge of the seal face adjacent the fluid under pressure. The radial channels may include a second radial channel that extends from the circumferential channel toward a second edge of the seal face adjacent a fluid at a lower pressure relative to the fluid under pressure.

### TECHNICAL FIELD

The present disclosure relates generally to rotary mechanical seals for fluid. More particularly, this disclosure relates to seals that include seal faces configured to promote penetration of fluid between the seal faces.

### BACKGROUND

Seals are used in a wide variety of applications including, for example, liquid pumps, mixers, agitators, and the like to provide fluid tight seals. Such seals are used to seal between rotating shafts and a housing in, for example, the chemical, pharmaceutical, gas and oil, power generation, mining and minerals, food and beverage, pulp and paper processing, wastewater and water management, and refrigeration industries. An example seal is an end face seal. End face seals include a seal interface that is lubricated by the fluid to be sealed or a separate barrier fluid introduced into the seal. When a seal interface is lubricated by the fluid to be sealed (e.g., process fluid), the fluid to be sealed may be driven into the seal interface via a hydrostatic effect and/or a hydrodynamic effect. The hydrodynamic effect promotes introducing process fluid into a seal interface with forces that are produced when a rotating portion of a seal interface is rotating, whereas the hydrostatic effect promotes introducing process fluid into a seal interface with just the forces resulting from a pressure differential across the seal interface.

### SUMMARY

The present disclosure relates generally to rotary mechanical seals for fluid, and more particularly, devices, systems, and methods for reducing friction between seal faces forming a seal interface.

According to one embodiment, the a hydrostatic seal assembly is disclosed. The seal assembly includes: a first ring having a first side bounded by a first edge and a second edge; and second ring having a second side facing the first side. In this embodiment, a circumferential channel extends along the first side between, and spaced from, the first edge and the second edge, a plurality of sub-channels extend from the circumferential channel along the first side of the first ring, and the first ring and the second ring form a seal between the first side and the second side.

In the seal assembly of any prior embodiment, the plurality of sub-channels include a plurality of first sub-channels extending from the circumferential channel to the first edge along the first side of the first ring.

In the seal assembly of any prior embodiment, the circumferential channel and the plurality of first sub-channels promote introducing fluid between the first side of the first ring and the second side of the second ring causing hydrostatic lift between the first side of the first ring and the second side of the second ring.

In the seal assembly of any prior embodiment, wherein the plurality of sub-channels include a plurality of second sub-channels extending along the first side from the circumferential channel toward the second edge.

In the seal assembly of any prior embodiment, the plurality of sub-channels extending from the circumferential channel are located on the first side of the first ring such that first sub-channels of the plurality of first sub-channels and second sub-channels of the plurality of second sub-channels extend from the circumferential channel in an alternating order along a length of the circumferential channel.

In the seal assembly of any prior embodiment, a second sub-channel of the plurality of second sub-channels extends from the circumferential channel to a terminal end spaced from the second edge.

In the seal assembly of any prior embodiment, a ratio of a circumferential distance between each first sub-channel of the plurality of first sub-channels to a radial span of each first sub-channel is about 8.

In the seal assembly of any prior embodiment, the first edge of the first ring is configured to be on a pressurized side of the seal.

In the seal assembly of any prior embodiment, the seal is configured to provide a seal against pressures on the pressurized side of the seal within a range of about 600 psi to about 1000 psi.

In the seal assembly of any prior embodiment, a ratio of a circumferential distance between each sub-channel of the plurality of sub-channels to a radial span of each sub-channel is about 4.

In the seal assembly of any prior embodiment, the circumferential channel is co-axial with one or both of the first edge and the second edge.

In the seal assembly of any prior embodiment, the first side of the first ring has a width extending from the first edge to the second edge and the circumferential channel is spaced from the first edge by a distance of one-third of the width of the first side of the first ring.

In the seal assembly of any prior embodiment, the circumferential channel a depth of about 0.002 inches.

In the seal assembly of any prior embodiment, the circumferential channel has a width between about 0.001 inches and 0.006 inches.

In the seal assembly of any prior embodiment, one or both of the first side of the first ring and the second side of the second ring are formed from one or more materials selected from a group consisting of carbon, silicon carbide, and tungsten carbide.

In the seal assembly of any prior embodiment, the circumferential channel includes a first circumferential channel portion and a second circumferential channel portion fluidly separated from the first circumferential channel portion.

Also disclosed is a liquid seal system configured to provide a seal between a housing defining a bore with pressurized fluid therein and a rotatable shaft extending through the bore. The seal system includes: a first annular ring having a first seal face; and a second annular ring having a second seal face facing the first seal face. An annular channel extends along the first seal face and a plurality of radial channels extend from the annular channel along the first seal face. The plurality of radial channels being fluidly connected via the annular channel. The first seal face and the second seal face interact via fluid received in the annular channel to form a hydrostatic seal.

In the seal system of any prior embodiment, a first set of the plurality of radial channels extend from the annular channel to a first edge of the first seal face.

In the seal system of any prior embodiment, a second set of the plurality of radial channels extend from the annular channel to a terminal end spaced from a second edge of the first seal face.

In the seal system of any prior embodiment, the first edge of the first seal face is an inner edge of the first annular ring and the second edge of the first seal face is an outer edge of the first annular ring.

In the seal system of any prior embodiment, the first edge of the first seal face is an outer edge of the first annular ring and the second edge of the first seal face is an inner edge of the first annular ring.

In the seal system of any prior embodiment, the first edge of the first seal face is on a higher pressure side of the hydrostatic seal than the second edge of the first seal face.

In the seal system of any prior embodiment, each radial channel of the first set of the plurality of radial channels extends a radial channel distance from the annular channel and each radial channel of the second set of the plurality of radial channels extends the radial channel distance from the annular channel.

In the seal system of any prior embodiment, the first annular ring is formed from a plurality of components.

In the seal system of any prior embodiment, the first seal face and the second seal face are formed from silicon carbide.

In the seal system of any prior embodiment, the annular channel and the plurality of radial channels promote introducing fluid between the first seal face and the second seal face to cause hydrostatic lift between the first seal face and the second seal face.

In the seal system of any prior embodiment, the annular channel and the plurality of radial channels form a continuous passageway for pressurized fluid from within the bore of the housing.

It shall be understood that any prior disclosed seal assembly can be included in a seal system.

Also disclosed is a method of forming an annular ring for a hydrostatic sealing assembly. The method includes: forming a circumferential channel in a surface of an annular ring; and forming a plurality of first radial channels in the surface of the annular ring, the plurality of first radial channels extending from the circumferential channel to a first edge of the surface. The circumferential channel fluidly connects the plurality of first radial channels in the surface of the annular ring.

In the method of any prior embodiment, the method can further include forming a plurality of second radial channels in the surface of the annular ring, the plurality of second radial channels extending from the circumferential channel toward a second edge of the surface. The circumferential channel can fluidly connect the plurality of first radial channels in the surface of the annular ring and the plurality of second radial channels in the surface of the annular ring.

In the method of any prior embodiment, the formed circumferential channel, the plurality of first radial channels, and the plurality of second radial channels take up less than five percent of a surface area of the surface of the annular ring.

In the method of any prior embodiment, the formed circumferential channel, the plurality of first radial channels, and the plurality of second radial channels are formed via laser engraving.

In the method of any prior embodiment, the circumferential channel and the plurality of first radial channels have a depth of about 0.002 includes.

In the method of any prior embodiment, the circumferential channel and the plurality of first radial channels have a width within a range of about 0.001 inches to about 0.006 inches.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments in connection with the accompanying drawings, in which:

FIG. 1 is a schematic sectional view depicting a portion of an illustrative seal assembly of the present disclosure between a housing and a rotating shaft;

FIG. 2 is a schematic plan view of an illustrative ring of a seal assembly having a seal face configuration with channels;

FIG. 3 is a schematic plan view of an illustrative ring of a seal assembly having a seal face configuration with channels;

FIG. 4 is a schematic magnified plan view of a portion of the illustrative ring of FIG. 2 that is within circle-4;

FIG. 5 is a schematic cross-section view of the illustrative ring of FIG. 4 taken along line 5-5;

FIG. 6 is a schematic cross-section view of the illustrative ring of FIG. 4 taken along line 6-6; and

FIG. 7 is a schematic cross-section view of the illustrative ring of FIG. 7 taken along line 7-7.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the term “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The term “diameter”, as used in this specification and the appended claims, is generally employed in its sense as being a line passing from side to side of an object unless the content clearly dictates otherwise. In some cases, the diameter of an object may pass through a center of the object and/or may be a longest line passing from side to side of the object.

As used in this specification and the appended claims, the singular forms “a”, “an”, and “the” include plural referents unless the content clearly dictates otherwise. As used in this specification and the appended claims, and although the term “and/or” is sometimes expressly recited herein, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used in connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

Mechanical seals may take on a variety of configurations. In pumps, mixers, agitators, and/or other systems utilizing a rotating shaft or portion, rotary mechanical end face seals may be utilized to facilitate a fluid tight seal between a housing and a rotating shaft. Such end face seals may include an axially-stationary annular ring (e.g., a mating ring) associated with the housing or the rotating shaft and an axially-adjustable annular ring (e.g., a primary ring) associated with the other of the housing or the rotating shaft. The axially-stationary ring and the axially-adjustable ring may include seal faces in a relatively rotating sealing relation to one another along a seal interface.

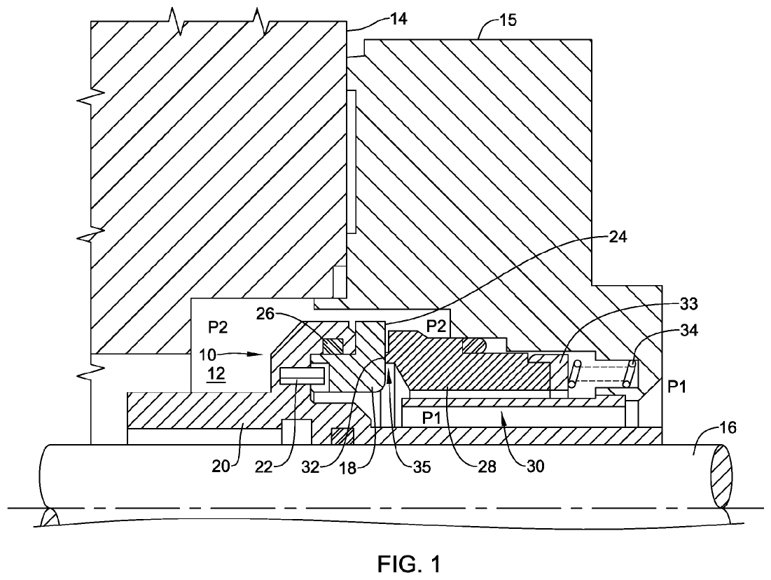

FIG. 1 depicts an illustrative seal arrangement in a seal assembly 10 (e.g., a rotary end face seal assembly) with process pressure or high pressure at an outer edge of the seal faces and ambient or low pressure (e.g., lower pressure than the process pressure or high pressure) at the inner edge of the seal faces. It is contemplated, however, that the processor pressure or high pressure may be at an inner edge of the seal faces and ambient or low pressure may be at an outer edge of the seal faces. The seal arrangement depicted in FIG. 1 may be configured to seal fluid, such as a liquid and/or a gas. Although the seal assembly 10 and configurations discussed herein may be primarily discussed with respect to sealing a process fluid that is a liquid (e.g., such that the seal assembly 10 is a liquid seal assembly or system), it is contemplated the seal assembly 10 and configurations may be utilized to seal a process fluid that is a gas (e.g., such that the seal assembly 10 is a gas seal assembly or system).

The seal assembly 10 depicted in FIG. 1 may seal fluid within a chamber 12 defined by a housing 14 and an attached gland plate 15. A shaft 16 may extend through the housing 14. In some cases, the shaft 16 may be configured to rotate relative to the housing 14 and a seal may be provided to inhibit or mitigate leakage of fluid from the chamber where the shaft 16 and the housing 14 meet.

The seal assembly 10 may include, among other components, a seal ring configuration including a primary ring 28 (e.g., a first ring or first annular ring) and a mating ring 18 (e.g., a second ring or second annular ring). As depicted in FIG. 1, the mating ring 18 may be configured to rotate with the shaft 16 and the primary ring 28 may be axially adjustable and rotationally fixed relative to the mating ring 18. The mating ring 18 and the primary ring 28, however, may be configured in different relative configurations including, but not limited to, the primary ring 28 rotating with the shaft 16 and the mating ring 18 remaining rotationally fixed relative to the primary ring 28.

As depicted in FIG. 1, the mating ring 18 may be rotationally fixed relative to a sleeve 20 by one or more pins 22. The sleeve 20 may be mounted on the shaft 16 and may rotate with the shaft 16 causing the mating ring 18 to also rotate with the shaft 16. An o-ring 26 may seal the mating ring 18 to the sleeve 20 to prevent leakage of a process fluid through the mating ring 18-sleeve 20 connection. The mating ring 18 may include a mating ring seal face 24 (e.g., an annular seal face or seal face taking on one or more other suitable configurations) defined by a first edge or outer edge and a second edge or inner edge. Further, mating ring 18 may be configured from a single component or two or more separable components connectable to form an annular ring.

The primary ring 28 may be retained within a gland adaptor assembly 30, as depicted in FIG. 1. The primary ring 28 may include a primary ring seal face 32 (e.g., an annular seal face or seal face taking on one or more other suitable configurations) defined by a first edge or an outer edge and a second edge or an inner edge. The primary ring seal face 32 may be configured to interact with the mating ring seal face 24 to form a seal interface 35 of the seal assembly 10. Further, the primary ring 28 may be configured from a single component or two or more separable components connectable to form an annular ring.

The primary ring 28 may be axially biased by a biasing mechanism 34 (e.g., a spring or other suitable biasing mechanism). The biasing mechanism 34 may bias the primary ring 28 toward the mating ring 18, urging the primary ring seal face 32 into face-to-face sealing relation with the mating ring seal face to form the seal interface 35. In some cases, a disk 33 may be situated axially between the biasing mechanism 34 and the primary ring 28.

The seal assembly 10, the housing 14, and the gland plate 15, and/or other suitable components may define a pressure zone P₂ (e.g., a pressure zone or process zone) in the chamber 12 upstream of the seal interface 35. A low pressure zone P₁ may exist downstream of the seal interface 35. The sealing configuration depicted in FIG. 1 may be referred to as an outside diameter (O.D.) pressurized seal assembly 10, where the pressurized process fluid is adjacent an outer diameter of the seal interface 35.

The seal interface 35 along the primary ring seal face 32 and the mating ring seal face 24 may inhibit process fluid from escaping the high pressure zone P₂ to the low pressure zone P₁. Because, in the configuration depicted in FIG. 1, the mating ring seal face 24 is wider in a radial direction than the primary ring seal face 32, the seal interface 35 may be coextensive with the radial extent of the primary ring seal face 32. In alternative configurations, the seal interface 35 may be defined by the mating ring seal face 24 operating against a primary ring seal face 32 of greater radial width than a radial width of the mating ring seal face 24.

In some cases, the seal interface may be lubricated via fluid (e.g., a process fluid of liquid and/or gas) under pressure within the housing, where the fluid is introduced to the seal interface via a hydrodynamic effect and/or a hydrostatic effect. To facilitate introducing process fluid to a seal interface with a hydrodynamic effect, one or more seal faces of the seal interface may include surface texturing that promotes introduction of process fluid into the seal interface while a rotating portion of the seal interface is rotating. Such surface texturing may include applying hydro-pad relieved areas or depressions on one or both of the seal faces forming the seal interface. One example of seal faces including hydro-pad relieved areas or depressions is disclosed in U.S. Pat. No. 4,407,512, which is hereby incorporated by references in its entirety for all purposes. Another example of seal faces including hydro-pad relieved areas or depressions is disclosed in U.S. patent application Ser. No. 14/875,098 and published as US 2016/0097456 A1, which is hereby incorporated by references in its entirety for all purposes.

Other surface texturing techniques to promote lubrication between seal faces include micro-dimple surface texturing. Typical micro-dimples had a diameter of about 0.004 inches and a dimple depth of about 0.0002 inches, which results in a dimple size to depth ratio on the order of about twenty (20). In some cases, a dimple area density on a seal face of a seal assembly of about twenty percent has been utilized.

Although the hydrodynamic effect and known surface texturing may be relied upon to lubricate the seal interface of a seal assembly during rotation of a rotating portion of the seal, it has been found that better lubrication may be desirable at static pressure conditions and upon startup of the rotating portion of the seal assembly (e.g., a portion configured to rotate with a rotating shaft of a pump) to minimize or mitigate seal face damage. Ensuring adequate lubrication upon startup of rotation of a rotating portion of a seal may be of particular concern where process fluid is kept under high pressures and/or where process fluid has a particular chemical make-up as hard materials that can withstand high pressures without deformation and/or that resist chemical corrosion may be utilized for the seal faces forming the seal interface.

Example materials utilized for the seal faces forming the seal interface include, but are not limited to, carbon (C), silicon carbide (SiC), tungsten carbide (WC), and the like. Hard materials utilized for the seal faces forming the seal interface may include SiC, WC, and the like.

Running hard material against hard material at a seal interface may cause wear and tear on the seal faces and limit a life of a seal assembly. Although the seal assembly may be configured such that one of the seal faces formed from the hard material may include a matte finish and the other seal face may have a plain polish finish to facilitate introducing process fluid into a seal interface due to hydrostatic effects, such a matte finish may decrease some hydrodynamic load support capability of the plain polish finish due to a larger gap between the matte finish face and the plain polish finish face Additionally, although hydro-pad face patterning or texturing may be utilized to assist in promoting the introduction of process fluid into the seal interface during rotation of the seal assembly, the applicant has appreciated that such a configuration may increase leakage without adequately encouraging lubrication at the seal interface in static pressure situations (e.g., upon startup, etc.). It has been found, however, that applying channels (e.g., micro-channel surface texturing patterns), as discussed herein, to one or both of the seal faces forming the seal interface may increase process fluid penetration into the seal interface, particularly at pump start up and/or static pressurized conditions, to separate the seal faces with lower leakage relative to leakage expected when utilizing hydro-pad patterning.

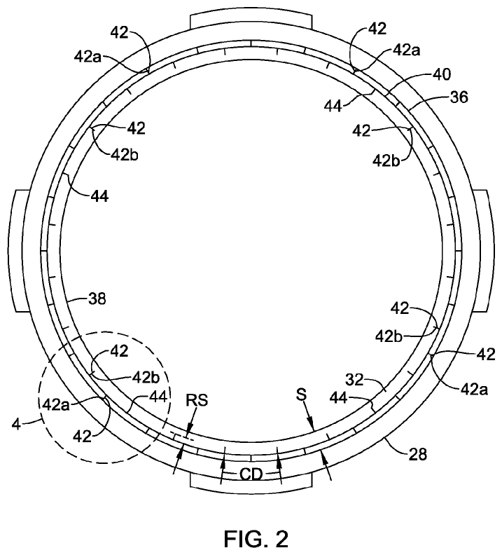

FIGS. 2-7 depict configurations of the primary ring seal face 32 configured to promote the introduction of process fluid between the primary ring seal face 32 and the mating ring seal face 24. Although the seal face configurations depicted in FIGS. 2-7 are discussed herein with respect to the primary ring 28, such configurations may be utilized additionally or alternatively on the mating ring seal face 24.

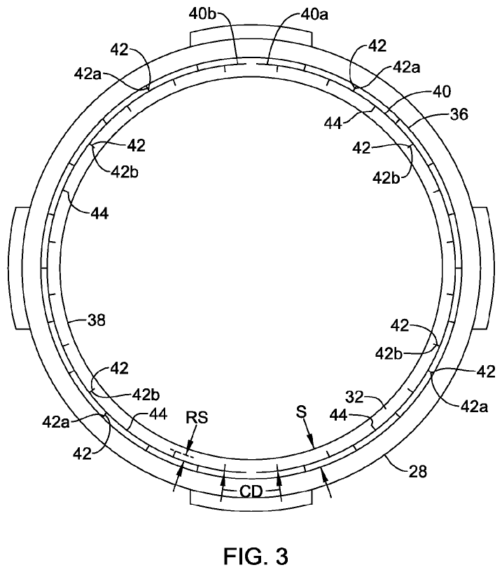

FIGS. 2 and 3 depict plan views of the primary ring 28 showing the primary ring seal face 32 defined by a first edge 36 (e.g., a radially outer edge or periphery) and a second edge 38 (e.g., a radially inner edge or periphery) of the primary ring 28. Although the first edge 36 is depicted and described herein as the outer edge and the second edge 38 is depicted and described herein as the inner edge, it is contemplated that the first edge 36 may be an inner edge and the second edge 38 may be an outer edge. The primary ring seal face 32 defines one or more channels that are configured to promote introducing process fluid between seal faces of a seal interface via a hydrostatic effect.

In the configuration depicted in FIG. 2, the first edge 36 may be configured to be exposed to the process fluid and associated pressures. The seal face configurations discussed herein may be configured to be utilized in seal assemblies 10 that are used to maintain a fluid under pressure. For example, the seal face configuration may be configured to facilitate lubrication within a seal interface when the fluid under pressure is held within a range from about 100 pounds per square inch (psi) or less to about 2000 psi or more, or other suitable range. In one example, the seal face configuration may be configured to facilitate lubrication within a seal interface when the fluid under pressure is held within a range from about 600 psi to about 1000 psi.

The channels depicted in the primary ring seal face 32 of FIG. 2 may include one or more circumferential channels 40 (e.g., when there are two or more circumferential channels 40, the circumferential channels 40 may be co-axial and/or take on one or more other suitable configurations) and a plurality of sub-channels 42 (e.g., radial channels or other channels radially extending from the circumferential channel 40). In some cases, the plurality of sub-channels 42 may extend from the circumferential channel 40 such that the circumferential channel 40 and at least some of the plurality of sub-channels 42 may be fluidly connected and/or may form a continuous passageway. Such a configuration of channels may facilitate directing fluid into the seal interface of the seal assembly 10, distributing the fluid along the circumference of the seal interface, and increase a fluid opening force between the seal faces (e.g., the primary ring seal face 32 and the mating ring seal face 24) to reduce mechanical loads on the seal faces and improve seal performance.

The channels (e.g., the circumferential channel 40 and the sub-channels 42) may be configured to take up a desired percentage of a surface area of the primary ring seal face 32 such that a leakage of process fluid may be mitigated. For example, the channels may be configured to take up less than about ten (10) percent, less than about five (5) percent, and/or other suitable amount of a surface area of the primary ring seal face 32. In one example, the channels may be configured to take up about three (3) percent of a surface area of the primary ring seal face 32.

The circumferential channel 40 may have an annular configuration (e.g., an annular channel having a single, continuous circumferential channel segment or portion forming a ring on or in the primary ring seal face, as depicted in FIG. 2) or the circumferential channel 40 may be formed from a plurality of circumferential channel segments or portions spaced from one another (e.g., as depicted in FIG. 3). When the circumferential channel 40 is formed from a plurality of circumferential channel segments or portions, the circumferential channel 40 may include two (2) circumferential channel segments (e.g., circumferential channel segments or portions 40a, 40b depicted in FIG. 3), three (3) circumferential channel segments or portions, four (4) circumferential channel segments or portions, or other suitable number of circumferential channel segments or portions. In some cases, each of the plurality of circumferential channel segments or portions may be located a same distance from a central axis of the primary ring 28.

The circumferential channel 40 may take on a suitable configuration for distributing fluid along the primary ring seal face 32. Example configurations may include, but are not limited to a circular configuration, an oval configuration, a star configuration, and/or other suitable configurations, as desired. In one example, the circumferential channel 40 may be generally circular and may be co-axial with one or both of the first edge 36 and the second edge 38 of the primary ring 28.

The circumferential channel 40 may be positioned at any location between the first edge 36 and the second edge 38 of the primary ring. In some cases, the circumferential channel 40 may be spaced from the first edge 36 and the second edge 38. For example, the primary ring seal face 32 may have seal face width S between the first edge 36 and the second edge 38, and the circumferential channel 40 (e.g., a center of the circumferential channel 40) may be located within a range of one-fourth to one-half of a distance of the seal face width S, or other suitable range, from the first edge 36 or otherwise an edge configured to be adjacent process fluid. In one example, the circumferential channel 40 may be located at one-third of a distance of the seal face width S from the first edge 36, as depicted in FIGS. 2 and 3.

The plurality of sub-channels 42 may include a plurality of first sub-channels 42a and a plurality of second sub-channels 42b. Alternatively, the plurality of sub-channels 42 may consist solely of a plurality of first sub-channels 42a.

The plurality of first sub-channels 42a may extend from the circumferential channel 40 to the first edge 36 defining the primary ring seal face 32. Such a configuration may facilitate promoting process fluid into the seal interface 35 as the plurality of first sub-channels in communication with the circumferential channel provide an avenue for pressurized process fluid to enter seal interface 35, circulate around the seal interface 35 via the circumferential channel 40 and hydrostatic effect, and cause hydrostatic lift between the primary ring seal face 32 and the mating ring seal face 24 when in use in a manner similar to the configuration depicted in FIG. 1. Such a configuration may form a hydrostatic seal between the primary ring seal face 32 and the mating ring seal face 24 at hydrostatic conditions, where a hydrostatic seal is known as a non-contacting mechanical seal that separates two different pressure zones used to establish a balanced pressure zone between two adjacent seal faces.

The plurality of second sub-channels 42b may extend from the circumferential channel 40 toward the second edge 38 defining the primary ring seal face 32. Such a configuration may facilitate process fluid promoting hydrostatic lift between the primary ring seal face 32 and the mating ring seal face 24 by providing an avenue for the process fluid to penetrate deeper into the seal interface 35 than a location of the circumferential channel 40. In some cases, one or more of the plurality of second sub-channels 42b may have a terminal end 44 prior to reaching the second edge 38 such that process fluid may be used to lubricate the seal interface 35 while mitigating leakage of process fluid through the seal interface 35.

The plurality of second sub-channels 42b may extend a distance from the circumferential channel 40 toward the second edge 38. The distance each of the second sub-channels 42b extend may be similar or the same for all of the second sub-channels 42b or one or more of the second sub-channels 42b may extend a distance from the circumferential channel 40 toward the second edge 38 that is different than a distance at least one other of the second sub-channels 42b may extend. In some cases, the second sub-channels 42b may extend a distance within a range of one-fourth to one-half of a distance of the seal face width S or other suitable range. In one example, one or more of the plurality of second sub-channels 42b may extend a distance of one-third of a distance of the seal face width S, as depicted in FIGS. 2 and 3.

When both are included in the configuration of the primary ring seal face 32, the plurality of first sub-channels 42a and the plurality of second sub-channels 42b may be configured in a suitable manner with respect to one another. For example, the first sub-channels 42a of the plurality of the first sub-channels 42a may extend from the circumferential channel 40 at a same location as one of the plurality of second sub-channels 42b, the first sub-channels 42a of the plurality of the first sub-channels 42 and the second sub-channels 42b may extend from the circumferential channel 40 in an alternating or staggered order along a length of the circumferential channel 40 (e.g., as depicted in FIGS. 2 and 3), and/or the plurality of first sub-channels 42a may be configured on the primary ring seal face 32 in one or more other suitable manners with respect to how the plurality of second sub-channels 42b are configured on the primary ring seal face 32.

The sub-channels 42 may be spaced a suitable distance from each other along the circumferential channel 40. In some cases, the sub-channels 42 may be spaced a consistent distance from one another along the length of the circumferential channel, but this is not required. In one example, an angular separation between a same type of sub-channels 42 (e.g., between two first sub-channels 42a or between two second sub-channels 42b) may be within a range from about ten (10) degrees to about thirty (30) degrees or other suitable range. Alternatively or in addition, a distance between sub-channels 42 may be based on a ratio of a circumferential distance CD between the same type of sub-channels 42 to a radial span RS of a sub-channel 42 (e.g., a distance from a center of the circumferential channel 40 to a terminal end of the first sub-channel 42a or the second sub-channel 42b). The ratio of a circumferential distance CD between the same type of sub-channels 42 to a radial span RS of a sub-channel 42 may be within a range from about four (4) to about twenty (20) or other suitable range. In one example, the sub-channels 42 of a same type of sub-channel may be spaced along a length of the circumferential channel 40 such that the ratio of circumferential distance CD between the same type of sub-channels 42 to a radial span RS of the same type of sub-channel 42 may be about or may be eight (8) or less to facilitate promoting hydrostatic lift at the seal interface 35 while mitigating leakage of process fluid through the seal interface 35. Alternatively or in addition, when the first sub-channels 42a and the second sub-channels 42b are consistently or equally staggered along the length of the circumferential channel 40, a ratio of the circumferential distance between any two adjacent sub-channels 42 to a radial span of a sub-channel may be or may be about four (4) to facilitate promoting hydrostatic lift at the seal interface 35 while mitigating leakage of process fluid through the seal interface 35. Other ratio values may be utilized, as desired, to determine a number of sub-channels to utilize and/or a spacing between adjacent sub-channels 42.

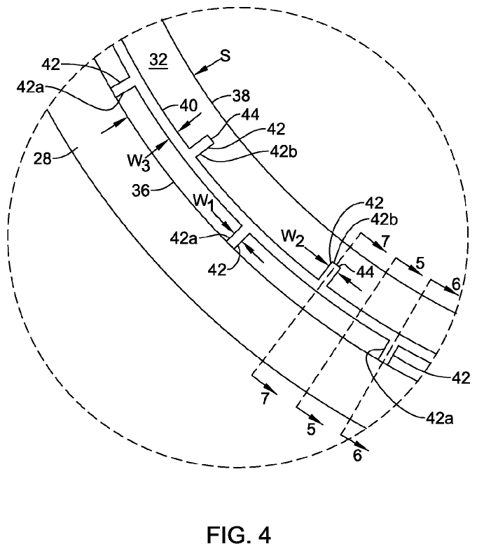

FIG. 4 is a magnification of a portion of the illustrative primary ring 28 in FIG. 2 that is within circle-4. As can be seen in FIG. 4, the first sub-channels 42a have a width W₁, the second sub-channels 42b have a width W₂, and the circumferential channel 40 has a width W₃. In some cases, the widths W₁, W₂, W₃ may be the same, however, it is contemplated that one or more channels may have a width that may be different than a width of at least one other channel. In some cases, the widths W₁, W₂, W₃ may be configured to facilitate a flow of process fluid through the channels. The widths W₁, W₂, W₃ may be within a suitable rage of widths, such as within a range extending from about 0.001 inches to about 0.006 inches or other suitable range. In one example, the widths W₁, W₂, W₃ may be about 0.005 inches.

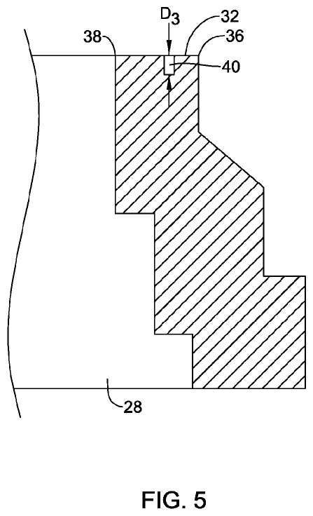

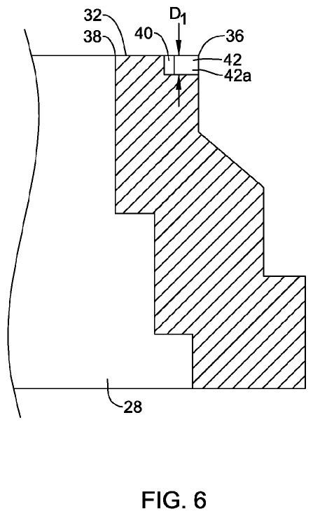

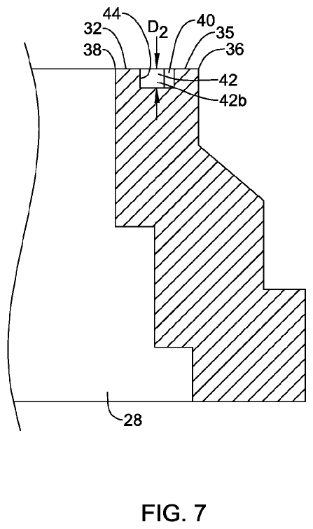

FIGS. 5-7 depict cross-sections of the primary ring 28 taken along lines 5-5, 6-6, and 7-7, respectively, of FIG. 4. In the cross-section of FIG. 5, the circumferential channel 40 is depicted in the primary ring seal face 32 as having a depth D₃. In the cross-section of FIG. 6, the first sub-channel 42a is depicted as extending from the circumferential channel 40 to the first edge 36 of the primary ring 28, where the first sub-channel 42a is depicted in the primary ring seal face 32 as having a depth D₁. In the cross-section of FIG. 7, the second sub-channel 42b is depicted as extending from the circumferential channel 40 to its terminal end 44, where the second sub-channel 42b is depicted in the primary ring seal face 32 as having a depth D₂.

The depths D₁, D₂, D₃ of the channels may be equal to one another or, alternatively, one or more of the depths D₁, D₂, D₃ may be different from another one of the depths D₁, D₂, D₃. In some cases, the depths D₁, D₂, D₃ may be configured to facilitate hydrostatic lift at the seal interface 35 by promoting the introduction of process fluid into the channels (e.g., the circumferential channel 40 and/or the sub-channels 42). Illustratively, the depths may be within a range of 0.001 inches and 0.005 inches or other suitable range. In one example, the depths D₁, D₂, D₃ may be equal to about 0.002 inches, which is an order of magnitude deeper than depths of about 0.0002 inches used for dimple surface texturing. Channels of such depth may facilitate serving as a reservoir for fluid (e.g., in the event of a loss of pressurized fluid) and/or for collecting wear debris from the seal faces (e.g., the primary ring seal face 32 and/or the mating ring seal face 24), if there is any, which may facilitate prolonging a life of the seal assembly 10.

The above described channels of the primary ring 28 may be formed in the primary ring 28 (or the mating ring 18) in a suitable manner capable of forming channels in hard materials (e.g., silicon carbide, tungsten carbide, etc.). In some cases, a laser (e.g., via laser engraving or ablating and/or other laser engraving or ablating techniques) or other suitable machining application may be utilized to form the circumferential channel 40 and/or the sub-channels 42 (e.g., the first sub-channels 42a and/or the second sub-channels 42b) in a surface of the primary ring seal face 32 of the primary ring 28 and/or a surface of the seal face 24 of the mating ring 18, such that the formed circumferential channel 40 and the formed sub-channels 42 are fluidly connected (e.g., in some cases, the fluidly connected formed circumferential channel 40 and formed sub-channels 42 may form a continuous passageway to facilitate pressurized process fluid traveling around the seal interface 35). A laser or other suitable machining application may be particularly configured to form the channels to the depths and widths described herein that promote introducing pressurized process fluid into the seal interface 35 while mitigating leakage of the process fluid all of the way through the seal interface 35.

As discussed above, channels of seal faces in the seal assembly 10 may be configured in a variety of manners to facilitate improved lift (e.g., hydrostatic lift) between seal faces of a seal interface and reduce wear and tear on the seal faces. Below is an example non-limiting seal configuration of a seal face incorporating the above-discussed illustrative concepts.

In an example, a four (4) inch outer diameter seal assembly with a seventy (70) percent balance ratio and utilizing SiC as the material for the primary ring seal face and the mating ring seal face may include a circumferential channel and a plurality of sub-channels on the primary ring seal face. The circumferential channel and the sub-channels had a depth of about 0.002 inches and a width of about 0.005 inches. The circumferential channel may be annular and located about one-third a width of the primary ring seal face from an outer diameter of the primary ring seal face, first sub-channels of the plurality of sub-channels may extend from the circumferential channel to the outer diameter circumference of the seal face, and second sub-channels of the plurality of sub-channels may extend from the circumferential channel toward an inner diameter circumference of the seal face about one-third the width of the primary ring seal face. The first sub-channels and the second sub-channels may be staggered equal distances away from one another. The sub-channels of a same type of sub-channel may be spaced along a length of the circumferential channel such that the ratio of circumferential distance between the same type of sub-channels to a radial span of the same type of sub-channel is about eight (8). Such a configured seal face assembly was tested for 100 hours in a pump holding water at 80 degrees Fahrenheit, the water having a maximum fluid pressure of 1000 psi, and the pump having a shaft rotation of 3600 rotations per minute. Post-test examination of the seal assembly revealed little wear, while leakage remained low (i.e., a leakage rate of 0-6 grams/hour) and/or within tolerances.

It should be understood that this disclosure is, in many respects, only illustrative. The various individual elements discussed above may be arranged or configured in any combination thereof without exceeding the scope of the disclosure. Changes may be made in details, particularly in matters of shape, size, and arrangement of steps without exceeding the scope of the disclosure. The disclosure's scope is, of course, defined in the language in which the appended claims are expressed.

1. A hydrostatic seal assembly for sealing a liquid comprising:
a first ring having a first side bounded by a first edge and a second edge; and
a second ring having a second side facing the first side;
wherein a circumferential channel extends along the first side between, and spaced from, the first edge and the second edge;
wherein a plurality of sub-channels extend from the circumferential channel along the first side of the first ring; and
wherein the first ring and the second ring form a hydrostatic seal between the first side and the second side.

2. The seal assembly of claim 1, wherein the plurality of sub-channels include a plurality of first sub-channels extending from the circumferential channel to the first edge along the first side of the first ring.

3. The seal assembly of claim 2, wherein the circumferential channel and the plurality of first sub-channels promote introducing fluid between the first side of the first ring and the second side of the second ring causing hydrostatic lift between the first side of the first ring and the second side of the second ring.

4. The seal assembly of claim 2, wherein the plurality of sub-channels include a plurality of second sub-channels extending along the first side from the circumferential channel toward the second edge.

5. The seal assembly of claim 4, wherein the plurality of sub-channels extending from the circumferential channel are located on the first side of the first ring such that first sub-channels of the plurality of first sub-channels and second sub-channels of the plurality of second sub-channels extend from the circumferential channel in an alternating order along a length of the circumferential channel.

6. The seal assembly of claim 4, wherein a second sub-channel of the plurality of second sub-channels extends from the circumferential channel to a terminal end spaced from the second edge.

7. The seal assembly of claim 2, wherein a ratio of a circumferential distance between each first sub-channel of the plurality of first sub-channels to a radial span of each first sub-channel is about 4.

8. The seal assembly of claim 2, wherein the first edge of the first ring is configured to be on a pressurized side of the seal, and the seal is configured to provide a seal against pressures on the pressurized side of the seal within a range of about 600 psi to about 1000 psi.

9. (canceled)

10. (canceled)

11. The seal assembly of claim 1, wherein the circumferential channel is co-axial with one or both of the first edge and the second edge.

12. The seal assembly of claim 1, wherein the first side of the first ring has a width extending from the first edge to the second edge and the circumferential channel is spaced from the first edge by a distance of one-third of the width of the first side of the first ring.

13. (canceled)

14. The seal assembly of claim 1, wherein the circumferential channel has a depth of about 0.002 inches and the circumferential channel has a width between about 0.001 inches and 0.006 inches.

15. The seal assembly of claim 1, wherein one or both of the first side of the first ring and the second side of the second ring are formed from one or more materials selected from a group consisting of carbon, silicon carbide, and tungsten carbide.

16. The seal assembly of claim 11, wherein the circumferential channel includes a first circumferential channel portion and a second circumferential channel portion fluidly separated from the first circumferential channel portion.

17. A liquid seal system configured to provide a hydrostatic seal between a housing defining a bore with pressurized liquid therein and a rotatable shaft extending through the bore, the liquid seal system comprising:
the seal assembly of claim 1;
wherein the plurality of radial channels are fluidly connected via the annular channel; and
wherein the first seal face and the second seal face interact via liquid received in the annular channel to form the hydrostatic seal.

18. A method of forming an annular ring for a hydrostatic sealing assembly, the method comprising:
forming a circumferential channel in a surface of an annular ring; and
forming a plurality of first radial channels in the surface of the annular ring, the plurality of first radial channels extending from the circumferential channel to a first edge of the surface;
wherein the circumferential channel fluidly connects the plurality of first radial channels in the surface of the annular ring.

19. The method of claim 18, further comprising:
forming a plurality of second radial channels in the surface of the annular ring, the plurality of second radial channels extending from the circumferential channel toward a second edge of the surface;
wherein the circumferential channel fluidly connects the plurality of first radial channels in the surface of the annular ring and the plurality of second radial channels in the surface of the annular ring.

20. The method of claim 19, wherein the formed circumferential channel, the plurality of first radial channels, and the plurality of second radial channels take up less than five percent of a surface area of the surface of the annular ring.

21. The method of claim 19, wherein the formed circumferential channel, the plurality of first radial channels, and the plurality of second radial channels are formed via laser engraving.

22. The method of claim 18, wherein the circumferential channel and the plurality of first radial channels have a depth of about 0.002 includes.

23. The method of claim 18, wherein the circumferential channel and the plurality of first radial channels have a width within a range of about 0.001 inches to about 0.006 inches.
